(19) United States
(12) Patent Application Publication
(10) Pub. No.: US 2023/0254688 A1
(43) Pub. Date: Aug. 10, 2023

(54) METHOD OF DIGITIZATION AND ACQUISITION OF SENSITIVE DATA ON MOBILE DEVICES THAT ENSURES THE SAFETY AND INTEGRITY OF THE DATA

(71) Applicants: Achille Pievani, Foresto Sparso (BG) (IT); Gabriele Lavelli, Foresto Sparso (BG) (IT); Lorenzo Muratori, Capriolo (BS) (IT); Luca Vegini, Viadanica (BG) (IT)

(72) Inventors: Achille Pievani, Foresto Sparso (BG) (IT); Gabriele Lavelli, Foresto Sparso (BG) (IT); Lorenzo Muratori, Capriolo (BS) (IT); Luca Vegini, Viadanica (BG) (IT)

(21) Appl. No.: 18/096,209

(22) Filed: Jan. 12, 2023

Related U.S. Application Data
(63) Continuation-in-part of application No. 16/301,630, filed on Nov. 14, 2018, now abandoned.

(30) Foreign Application Priority Data
May 16, 2016 (IT) 102016000049931

(51) Int. Cl. H04W 12/02; H04W 12/033

(52) U.S. Cl. CPC H04W 12/02; H04W 12/033

(57) ABSTRACT

A method for digitization and acquisition of sensitive data on mobile devices, that ensures the security and integrity of the data, the method comprising the steps of:

a. downloading on a mobile device a software application implementing functions of the invention;
b. inserting in said software application the user registration data;
c. inserting in said software application the mobile device data: imei code and iccid code;
d. creating a password or a PIN code to ensure the safety of the application access;
e. requesting an organizational entity to issue a first certified document, by sending a request directly by the mobile device software application;
f. getting on the mobile device the first certified document, in a specific folder always available to the user.

### BACKGROUND OF THE INVENTION

### 1. Field of the invention

The present invention relates to a method for digitizing and capturing sensitive data on electronic devices, in particular on smartphones or tablets. The present invention also relates to a method of information security for privacy protection to ensure the integrity of individual data acquired, confidential personal information, and to facilitate the creation, use and safe access to this information from a public or private network, through portable electronic devices.

### 2. Brief Description of the Prior Art

As is well known, methods and software for digitizing documents and standard information that solve document retrieval and document retrieval issues are widely widespread and commonly used. Also widely used are methods to ensure the confidentiality and integrity of the data.

For example, document No. WO02/06948 describes a method for creating, storing and displaying personal data and confidential information using portable electronic devices, while document TW201520806 concerns a system for identity authentication for a mobile device, which includes a plurality of software for exchanging information connected to the host. That system includes a form to verify the identity of the person by means of a verification code. Therefore, the invention has the advantage of reducing the risk of frauds and making digital business cards and other data.

Document US2016/0087971 A1 discloses a method and a system for generating identification and certification of e-licenses includes the use of software, applications and mobile devices such as smartphones. It is designed to issue and manage all kinds of permits, e-licenses or other documents intended for identification and certification of specific documents and permits in any defined area. However this method does not allow a one-to-one relationship between users and competent authorities.

### SUMMARY OF THE INVENTION

Aim of the present invention is to provide a method for digitizing sensitive data on a mobile device of a user, such as a smartphone or tablet. The method is fast and efficient, at the same time guarantees the security and integrity of the same and is not present in the state of the art.

The method of digitizing sensitive data object of the present invention is designed to optimize the digitization of any type of document and ensure the security and integrity of such data.

According to the present invention, a method for digitizing sensitive data on electronic devices that guarantees the security and integrity of the data itself is defined by the features set forth in the attached independent claim.

Further embodiments of the invention, preferred and/or particularly advantageous, are described in accordance with the features disclosed in the enclosed dependent claims.

### BRIEF DESCRIPTION OF THE DRAWINGS

Certain preferred embodiments of the invention, but without any limitation, are described below, with reference to the accompanying drawings, in which:

FIG. 1 is a flow-chart of a method of digitization and acquisition of sensitive data on mobile devices according to the present invention;

FIG. 2 is a flow-chart of the detail of the insertion of personal data;

FIG. 3 is a flow-chart of the method for managing the request of documents from the user to the responsible authorities.

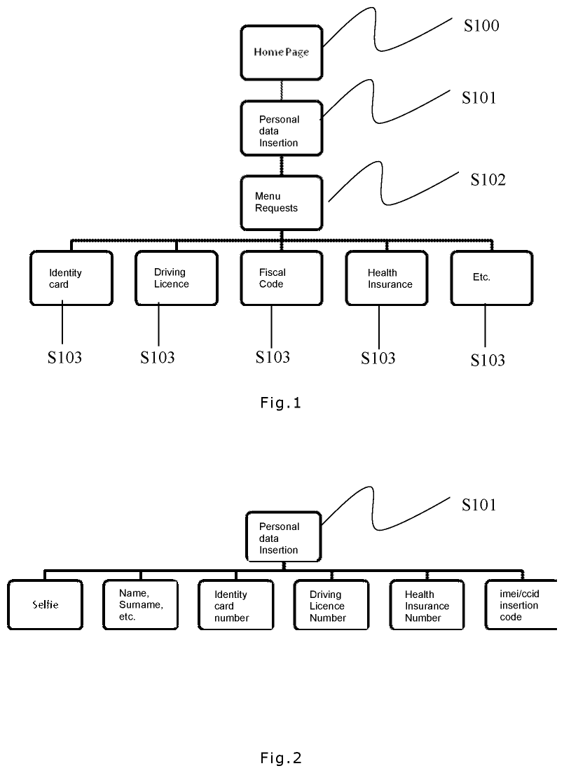

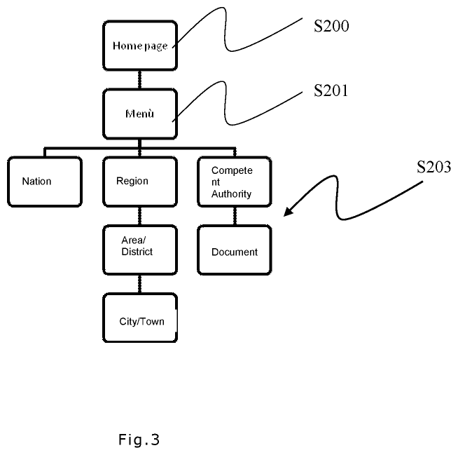

### DETAILED DESCRIPTION OF THE INVENTION

The method for digitizing and capturing sensitive data on mobile devices e.g smartphones and tablets, that ensures the security and integrity of the data itself, is implemented on a software application downloadable on mobile devises and on a computer software which is resident on personal computers or servers belonging to an organizational entity, for example city offices, department of motor vehicles, sanitary presidia, banks, and so on.

The method comprises the steps of:

a. downloading on a user mobile device the software application implementing functions of the invention;

b. inserting S101 in said software application the user registration data. As an example such registration data can comprise: user first and last name, date of birth, place of birth, social security number, identity card number, phone number, email address, selfie data, Federal Tax Identification Number (EIN) or Social Security Number (SSN), driving license. As a further example user registration data can also comprise fingerprint insertion, iris or facial recognition and the entry of any other user data useful to identify the user.

c. inserting S101 in said software application the mobile device data: imei (International Mobile Equipment Identity) code and iccid (Integrated Circuit Card Identification number) code. The imei code is a unique 15-17-digit code that is given to every mobile phone. This number is used by service providers to uniquely identify valid devices. Specifically, IMEI code can enable a Global System for Mobile communication (GSM) or Universal Mobile Telecommunications Service (UMTS) network to prevent a misplaced or stolen phone from initiating calls. The iccid code is a unique 18-22-digit code that includes a SIM card's country, home network, and identification number. Unlike an imei number, which refers to the mobile device, an iccid number refers to the SIM card itself. The combination of imei/iccid codes allows a unique identification of the user mobile device;

d. creating a password or a PIN code to ensure the safety of the application access; preferably the password could be an alphanumeric string having at least eight character; preferably the PIN code could be a 4-digit code.

Following the installation of the software application and the registration data according to steps a.-d., the method comprises the steps of:

e. requesting S102 the organizational entity to issue a first certified document (for example an identity card), by sending a request directly by the mobile device software application; to the request, user registration data and mobile device data will be joined;

f. getting S103 on the mobile device the certified document, in a specific folder always available to the user. Said document is uploaded to the mobile device only and exclusively by the organizational entity directly from the computer software implementing the functions of the invention and available to the organizational entity. Each document sent to the user will have an associated alphanumeric code, so that said document is considered valid and official.

The associated alphanumeric code is generated by means of said computer software as a univocal function of the user data and the mobile device data. Therefore, this alphanumeric code will always univocally identify the combination user/mobile device. Whenever the user will request further certified documents, the alphanumeric code will be printed also on such further certified documents. Of course, further documents have to be requested by the user always through the same mobile device and with the same SIM.

For this reason, if the mobile device is replaced by a different one, the user must carry out method steps from a. to f. again. Following a request of a first certified document, a new associated alphanumeric code will be generated by the computer software on such certified document requested by the user. Same procedure has to be executed by the user in case the mobile device is lost or stolen, or the SIM is blocked for any reason: the user by using a new mobile device and/or a new SIM will execute method steps from a. to f.

The computer software used by the organizational entity, equipped with customizable menu S201, allows to process the request, retrieve the requested document from appropriate national or regional or provincial or communal database S203 and, always by means of the computer software, send the certified document with the relevant alphanumeric code to the user mobile device. This certified document, saved by the user on the application folder, may be considered valid for any legal effect and may be sent by the mobile device by e-mail, Bluetooth or any other telematics mode to public and private offices.

The certified document can also be displayed directly from the mobile device to any authority (e.g. police) asking to check such document.

Advantageously, the computer software connected to the software application will be developed as a single software nationwide to meet any possible document request.

Even more advantageously, each authority can access only and exclusively its own competent department and will have a preloaded list of all national cities/towns.

Whenever national or regional or provincial or communal database would have a backup copy into a national server (e.g. cloud managed by block chain technology) the computer software of the organizational entity can be connected to the national server. For instance, national agencies, hotels, shops, banks, etc., can use the computer software connected to the national server to verify personal identity only by entering the user associated alphanumeric code. In fact, entering the user associated alphanumeric code, the computer software will associate to this code, user registration data and mobile registration data. With this data the computer software will query the national server a certified document which verifies the user identity. As an alternative, if the national server is also provided with the same computer software, it will be sufficient to communicate to the national server just the associated alphanumeric code.

In the same way, it will be possible to create a dedicated website linked to the national server to verify the personal identity by entering the associated alphanumeric code.

The software application, implementing the method according to the present invention, can be organized as follows:
at least a registration module,
at least a document request module.

The registration module includes a first display mask requiring user registration data: first and last name, date of birth, place of birth, social security number, identity card number, phone number, email address, selfie data, Federal Tax Identification Number (EIN) or Social Security Number (SSN), driving license, number and data of the user mobile device.

In a second display mask, the registration module will ask for a selfie and/or a fingerprint. After that, a password or a pin code generation is required.

All the above data will be sent to a suitable server and a receipt of a successful registration will be received by the user.

The document request module is organized with a home page and a main menu:
available documents
document request
document elimination

The available documents are the ones a user can ask to different competent authorities. As an example, city offices, department of motor vehicles, sanitary presidia, banks, and so on.

From these authorities the documents which can be request are, for instance: identity card, birth certificate, family status declaration from the city offices; driving licenses, boat license and so on from the department of motor vehicles; certificate of good health, health book, health insurance card from the sanitary presidia; account balance, loan, mortgage etc. from the bank.

It is understood that the invention is not limited to the embodiments described and illustrated here, which are to be considered as examples of the assembly and of the processes for assembling it; those skilled in the art will understand that it is possible to make various changes as regards shapes, sizes, constructive and functional details and configuration of the elements described in the exemplary embodiment, without departing from the scope of the invention as defined in the appended claims and their equivalents.

1. A method for digitization and acquisition of sensitive data on mobile devices, said method ensures the security and integrity of the data, the method comprising the steps of:
a. downloading on a mobile device a software application implementing functions of the invention;
b. inserting in said software application the user registration data: user first and last name, date of birth, place of birth, social security number, identity card number, phone number, email address, selfie data, Federal Tax Identification Number (EIN) or Social Security Number (SSN), driving license;
c. inserting in said software application the mobile device data: imei code and iccid code;
d. creating a password or a PIN code to ensure the safety of the application access;
e. requesting an organizational entity to issue a first certified document, by sending a request directly by the mobile device software application;
f. getting on the mobile device the first certified document, in a specific folder always available to the user; wherever said first certified document is uploaded to the mobile device only and exclusively by the organizational entity directly from a computer software implementing the functions of the invention and available to the organizational entity, wherein each document sent to the user will have an associated alphanumeric code, so that said document is considered valid and official; and wherein said associated alphanumeric code is generated by means of said computer software as a univocal function of the user data and the mobile device data; and wherein the same alphanumeric code will be printed also on further certified documents requested by the user.

2. The method according to claim 1, further comprising in the step b. the addition of using a fingerprint, iris or facial recognition, and any other user data useful to identify the user.

3. The method according to claim 1, whenever said mobile device is replaced by a different one or the SIM is blocked, steps from a. to f. have to be carried out again and a new associated alphanumeric code is generated by the computer software on the certified documents requested by the user.

4. The method according to claim 1, wherein said mobile device is lost or stolen, steps from a. to f. have to be carried out again and a new associated alphanumeric code is generated by the computer software on the certified documents requested by the user.

5. The method according to claim 1, wherein said organizational entity can access only and exclusively its own department and will have a preloaded list of all national cities/towns.

6. The method according to claim 1, wherein the first or the further certified document, are saved by the user on the application folder, are sent by e-mail, Bluetooth or any other telematics mode to public and private offices and are displayed directly from the mobile device to any authority.

7. The method according to claim 1, wherein national or regional or provincial or communal database have a backup copy into a national server and the computer software of the organizational entity is connected to the national server.

8. The method according to claim 1, wherein a dedicated website is linked to the national server to verify the personal identity by entering the associated alphanumeric code.

9. The method according to claim 1, wherein said certified document is selected from the group consisting of identity card, birth certificate, family status declaration from the city offices; driving licenses, vehicle licenses; certificate of good health, health certificates, health insurance card from sanitary authority, account balance, loans, mortgages.

10. The method according to claim 1, wherein said software application comprises:
at least a registration module,
at least a document request module;
and wherein said registration module comprises a first display mask requiring personal data of a user to be registered using first and last name, date of birth, place of birth, social security number, identity card number, phone number, email address, selfie data, Federal Tax Identification Number (EIN) or Social Security Number (SSN), driving license and data of the user mobile device,
and wherein said registration module comprises a second display mask, requiring a selfie and a fingerprint;
and wherein said registration module requires a password or a PIN code generation;
and wherein said document request module is organized using a home page and a main menu comprising:
available documents
document request
document elimination.
